(19) United States
(12) Patent Application Publication
(10) Pub. No.: US 2008/0261429 A1
(43) Pub. Date: Oct. 23, 2008

(54) WATERPROOF AND/OR DUSTPROOF PROTECTION DEVICE FOR ELECTRICAL CONNECTOR IN TUBULAR RADIATION EMITTER AND METHODS OF USING THE SAME

(76) Inventor: Andrzej Wronski, Podkowa Lesna (PL)

Correspondence Address: MATTHIAS SCHOLL, 14781 MEMORIAL DRIVE, SUITE 1319, HOUSTON, TX, 77079, US

(21) Appl. No.: 12/147,509

(22) Filed: Jun. 27, 2008

Related U.S. Application Data
(63) Continuation of application No. PCT/PL2006/000017, filed on Mar. 10, 2006.

(30) Foreign Application Priority Data
Dec. 27, 2005 (PL) P-378532

(51) Int. Cl. H01R 13/52

(52) U.S. Cl. 439/271

(57) ABSTRACT

A waterproof and/or dustproof protection device for an electrical connector in a tubular radiation emitter disposed in a housing comprising a protective cover, the protective cover comprising a passage and a plurality of gaskets, wherein the protective cover forms an airtight space within which the electrical connector is placed; the protective cover is a separate element, not related by shape to the housing of the tubular radiation emitter; the passage, at one of its ends, adheres circumferentially with its inner or outer surface to a first gasket disposed at one end of the tubular radiation emitter, and, at its other end, adheres circumferentially with its inner or outer surface to a second gasket; and the second gasket adheres to an insulation of a power cord. The device is applicable to outdoor tubular emitters of visible, ultraviolet, and infrared radiation, etc., in high moisture and/or high dust conditions.

### CROSS-REFERENCE TO RELATED APPLICATIONS

This application is a continuation of International Patent Application No. PCT/PL2006/000017, with an international filing date of Mar. 10, 2006, designating the United States, now pending, and further claims priority benefits to Polish Patent Application No. P-378532, filed Dec. 27, 2005. The contents of these specifications including any intervening amendments thereto are incorporated herein by reference.

### BACKGROUND OF THE INVENTION

1. Field of the Invention

The invention relates to a tubular radiation emitter and more particularly to a moisture and/or dust protection device for a tubular radiation emitter.

2. Description of the Related Art

Electrical wires supplying electricity to tubular radiation emitters are conventionally joined to an external power cord via electrical connectors with ceramic housing. The electrical connectors are typically enclosed in the same radiator housing as are the emitters. However, this type of protection is largely ineffective and does not meet safety standards for operating in open environments.

Known are also radiation devices with tubular radiation emitters which meet safety standards for operating outdoors. Protecting electrical connections from moisture is achieved in these devices though a sealed external housing. For example, known are moisture-proof lighting enclosures in which a metal-made support for electrical elements is affixed to a plastic bottom support section, and a reflector, fluorescent lamps, and an upper cover are affixed thereto.

However, enclosing infrared heating radiators in fully-sealed enclosures causes problems with heat removal from areas of electrical connectors, the emitter, and the enclosure, because when in use, these type of devices generate high temperatures around the emitter.

From Polish Pat. Appl. No. P-364033 known is an infrared heating radiator with a tubular radiation emitter placed in a reflector and affixed to the side walls of a housing. The tubular radiation emitter is connected to a light emitter. The housing of the heating radiator is located on the same axis as the housing of the light emitter. Electric wiring for both radiation sources is run through a mutual channel. In this type of radiator, thermal protection of the exiting electric wiring and of both radiation sources is realized; however, the electrical connection of the infrared emitter to the power cord is not protected from moisture.

In addition, from Intl. Pat. Publ. No. WO2005/036928, known is a radiation device wherein a heating radiation emitter is protected against vibration and mechanical stresses created due to thermal expansion inherent to such type of devices. This device includes a carrier mount provided with two hooking assemblies that carry a tubular radiation emitter. The tubular radiation emitter is connected to the hooking assemblies though elastic connecting elements, each placed at one end of the radiation emitter so as to act both as a shock absorber and a sealing agent. The hooking assemblies define a shielding space for protecting electrical connectors.

The above-mentioned solutions leave much to be desired in the field of tubular radiation emitter protection as they are not universally-applicable. Accordingly, much opportunity for improvement exists.

### SUMMARY OF THE INVENTION

One object of this invention is to develop a universal device for protecting electrical connectors of a tubular radiation emitter from moisture and/or dust, the design of which is independent from the housing structure, as well as from the structure of the emitter itself.

In accordance with one embodiment of the invention provided is a waterproof and/or dustproof protection device for an electrical connector in a tubular radiation emitter disposed in a housing, comprising a protective cover, the protective cover comprising a passage and a plurality of gaskets, wherein the protective cover forms an airtight space within which the electrical connector is placed; the protective cover is a separate element, not related by shape to the housing of the tubular radiation emitter; the passage, at one of its ends, adheres circumferentially with its inner or outer surface to a first gasket disposed at one end of the tubular radiation emitter, and, at its other end, adheres circumferentially with its inner or outer surface to a second gasket; and the second gasket adheres to an insulation of a power cord.

In another embodiment or in a class of this embodiment, the airtight space is limited by an elastic element tightly surrounding one end of the radiation emitter.

In another embodiment or in a class of this embodiment, the protective cover is placed around the electrical connector of the tubular radiation emitter.

In another embodiment or in a class of this embodiment, the insulation of a power cord comprises a flanged metal sleeve and an elastic insulation material, and the elastic insulation material is clamped to the flanged metal sleeve.

In another embodiment or in a class of this embodiment, the insulation of a power cord surrounds the power cord in its entire length up to an electrical plug.

In another embodiment or in a class of this embodiment, the first gasket that adheres to outer surface of the passage has a tubular shape with a first longitudinal through-hole; the cross-section of the first longitudinal through-hole is matched at one end to the outer surface of the passage and at another end to the outer surface of the tubular radiation emitter.

In another embodiment or in a class of this embodiment, the second gasket has a tubular shape with a second longitudinal through-hole; and the cross-section of the second longitudinal through-hole is matched at one end to the outer surface of the passage and at another end to the insulation of a power cord or to an additional cover of the power cord.

In another embodiment or in a class of this embodiment, the first gasket is made of at least two separate parts, the two separate parts being joined form a tubular structure, the tubular structure being tightly fit to the inside surface of the passage and being tightly fit to the outer surface of the tubular radiation emitter to which it is fixed; and the separate gasket parts are joined with a bonding agent.

In another embodiment or in a class of this embodiment, the passage has a straight or curved axis of symmetry and comprises at least one tubular section having a through-hole and/or a T-shaped section.

In another embodiment or in a class of this embodiment, the passage further comprises at least one radiator or the passage is connected to at least one radiator.

In another embodiment, this invention provides a heating radiator comprising a tubular radiation emitter disposed in a housing, and at least one electrical connector for connecting the tubular radiation emitter to a power cord, wherein the electrical connector is protected by the device described herein.

In another embodiment or in a class of this embodiment, the first gasket and the second gasket are made of elastic material resistant to high temperature.

In another embodiment or in a class of this embodiment, the protective cover is made of a highly thermally-conductive material, such as copper.

In another embodiment or in a class of this embodiment, the passage is filled with a cooling agent.

In another embodiment or in a class of this embodiment, cooling agent surrounds the electrical connector.

The waterproof and/or dustproof protection device is simple in structure, universally applicable, and effectively protects electrical connectors against moisture and dust. Therefore, the device of the invention meets safety standards for operating outdoors, and/or in conditions of high moisture and/or dust.

The waterproof and/or dustproof protection device is not only applicable in heating radiators used, e.g., in outdoor restaurants or terraces, but is also applicable for use in manufacturing settings. The protection device reduces the overall cost of the radiator, improves its safety, and allows for a lighter and more esthetically pleasing construction. The device makes it possible to repair the heating radiators more quickly. The device makes it also possible not to use a full protective cover, increasing the efficiency by over 20%.

The embodiment that features a gasket disposed within the interior of the passage allows for the use of emitters with larger density of infrared radiation, which expands the area of its applicability. Specifically, the device is universally-applicable because it is independent of the shape of the radiator housing.

### BRIEF DESCRIPTION OF THE DRAWINGS

The invention is described hereinbelow with reference to accompanying drawings, in which:

FIG. 1 is a cross-sectional view of the waterproof and dustproof protection device for a tubular radiation emitter according to one embodiment of the present invention, in which two gaskets are disposed one at each end of outer side surfaces of the passage;

FIG. 2 is a cross-sectional view of the gasket shown in FIG. 1;

FIG. 3 is a cross-sectional view of the waterproof and dustproof protection device for a tubular radiation emitter according to another embodiment of the present invention, in which one gaskets is disposed one at one end of the outer side surface of the passage, and another gasket is disposed in the interior of the passage;

FIG. 4 shows the gasket prepared to be disposed within the passage illustrated in FIG. 3;

FIG. 5 is a cross-sectional view of the waterproof and dustproof protection device for a tubular radiation emitter according to another embodiment of the present invention, in which the passage is made of three tubular sections;

FIG. 6 is a cross-sectional view of a radiator profile making up the passage according to another embodiment of the invention;

FIG. 7 is a cross-sectional view of an elbow-shaped passage according to another embodiment of the invention;

FIG. 8 is a cross-sectional view of an T-shaped passage according to another embodiment of the invention;

FIG. 9 is a cross-sectional view of the waterproof and dustproof protection device for a tubular radiation emitter according to another embodiment of the present invention, in which the passage and the power cord insulation are hermetically sealed with one another;

FIG. 10 is a cross-sectional view of the waterproof and dustproof protection device for a tubular radiation emitter according to another embodiment of the present invention, in which the radiation emitter is mounted in the housing side walls;

FIG. 11 is a cross-sectional view of the waterproof and dustproof protection device for a tubular radiation emitter according to another embodiment of the present invention, in which the radiation emitter is mounted in the side walls of the housing and the passage has a T-shape; and

FIG. 12 is a cross-sectional view of the waterproof and dustproof protection device for a tubular radiation emitter according to another embodiment of the present invention, in which the radiation emitter emits high density radiation and is disposed in elastic clamps.

### DETAILED DESCRIPTION OF THE EMBODIMENTS

### EXAMPLE 1

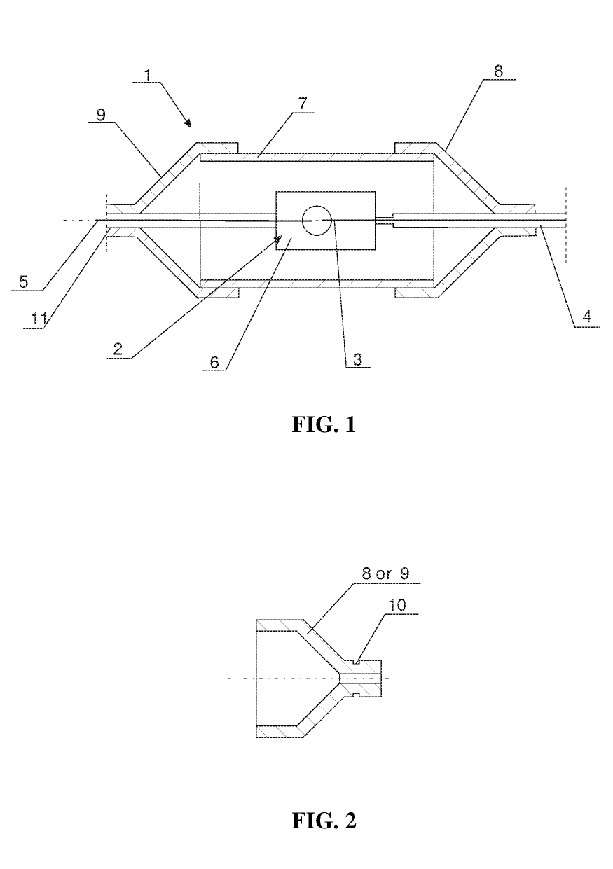

With reference to FIG. 1, the waterproof and dustproof protection device for a tubular radiation emitter comprises a protective cover 1. Within the protective cover 1 disposed is an electrical connector 2. The electrical connector 2 disconnectably connects electrical wires 3 of the tubular radiation emitter 4 and electrical wires of the power cord 5. The wires are connected within the ceramic block 6. The protective cover 1 comprises further a single passage 7 having a straight axis of symmetry; and elastic silicone gaskets 8 and 9 made of high temperature-resistant silicone. The gaskets 8 and 9 are of a bell-shaped design with a central opening passing through along the axis of symmtry. The gasket 8 adheres circumferentially to the outer side surface of the passage 7 and also adheres circumferentially to the tubular radiation emitter 4. The gasket 8 shown in FIG. 2 additionally comprises the circumferential groove 10. The gasket 9 adheres circumferentially to the outer side surface of the passage 7 and also adheres circumferentially to the insulation 11 of the power cord 5.

### EXAMPLE 2

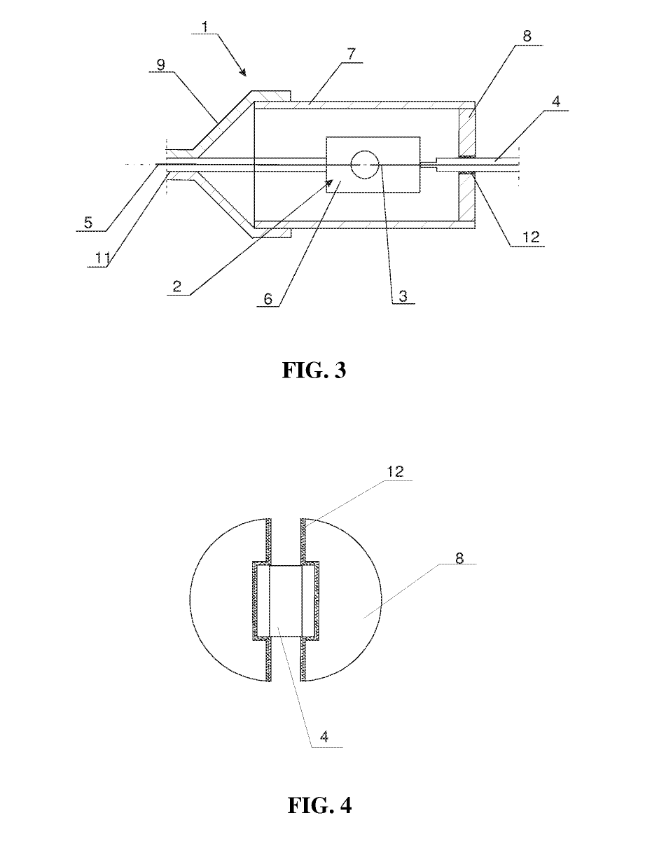

The protection device shown in FIG. 3 is used preferably in radiators with a tubular radiation emitter emitting large density infrared radiation. In this example, the protective cover 1 is provided at the end connected to the tubular radiation emitter 4 with a dual part gasket 8 that enters the interior of the passage 7. The dual part gasket 8 is covered at its joints with bonding agent 12 as shown in FIG. 4. The bonding agent is a silicone glue which is resistant to 800° C.

### EXAMPLE 3

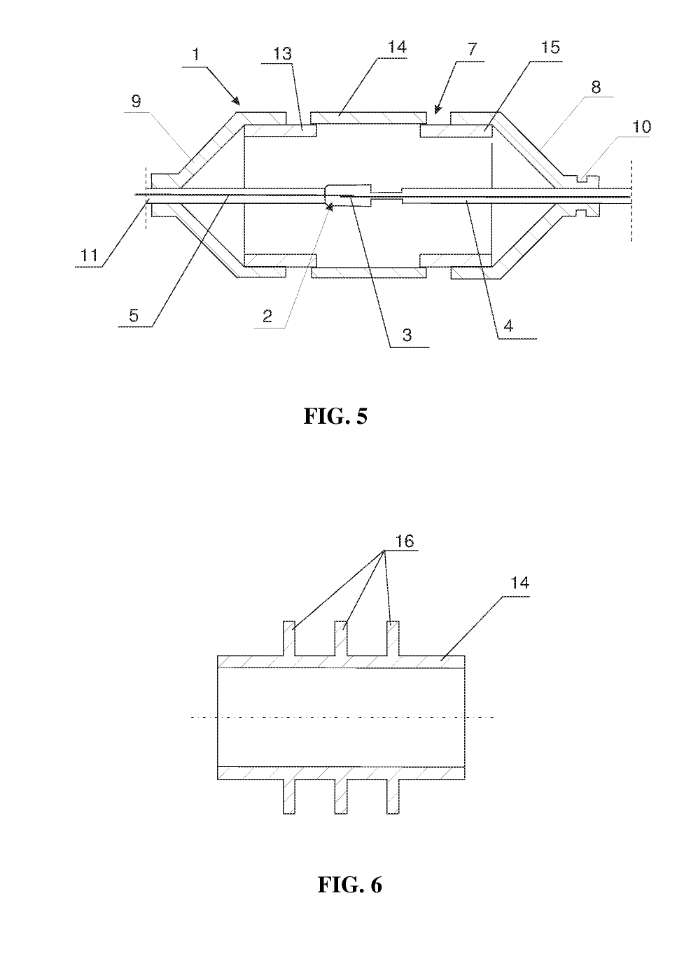

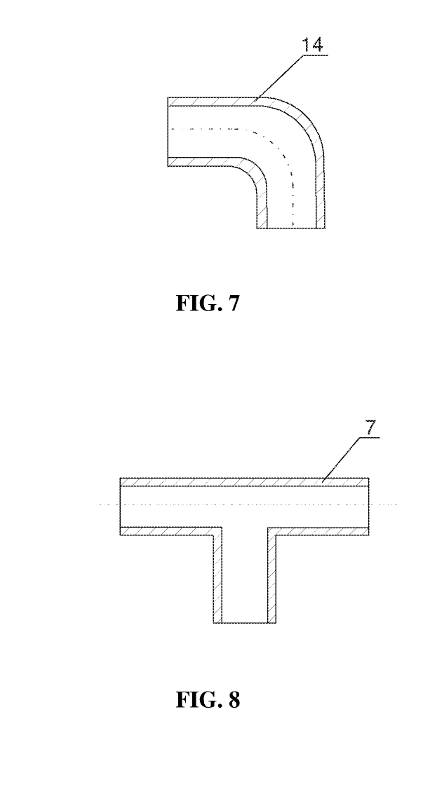

With reference to FIG. 5, the electrical connector 2 connecting the electrical lead wires 3 coming from the tubular radiation emitter 4 and electrical wires of the power cord 5, is provided as a non-disconnectable connector, e.g., a heat-sealed connector, protected by the protection device. In this example, the passage 7 of the protective cover 1 comprises three interconnected profiles 13, 14 and 15. These profiles are of tubular shape. The middle profile 14 can be equipped with radiators 16, as shown in FIG. 6, or can be in the form of an elbow, as shown in FIG. 7.

### EXAMPLE 4

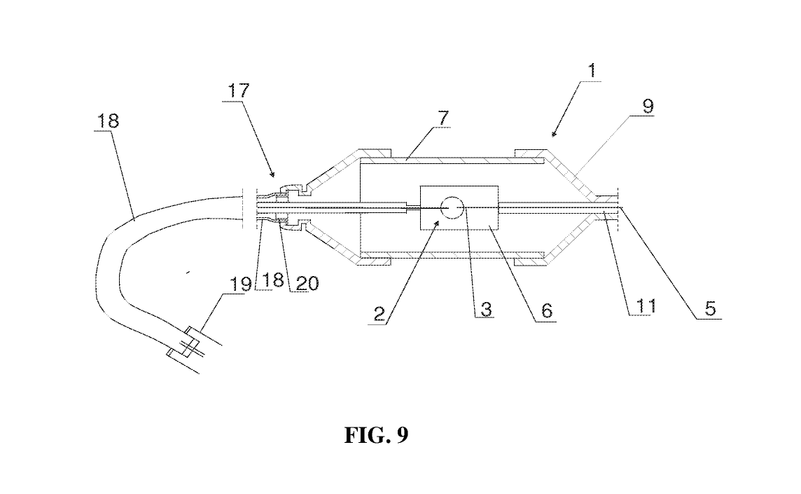

With reference to FIG. 9, the protection device comprises further an insulation of the power cord as one airtight entity. In this device, the gasket 9 made of high temperature-resistant silicone adheres circumferentially to the end 17 of the elastic insulation 18 also made of high temperature-resistant silicone. The insulation 18 encloses the power cord 5 along its entire length up to the plug 19. The end 17 of the insulation 18 comprises a flanged metal sleeve 20 to which the insulation 18 is clamped. This configuration of the end 17 allows the gasket 9 to be permanently joined with the insulation 18 to form a hermetic seal.

### EXAMPLE 5

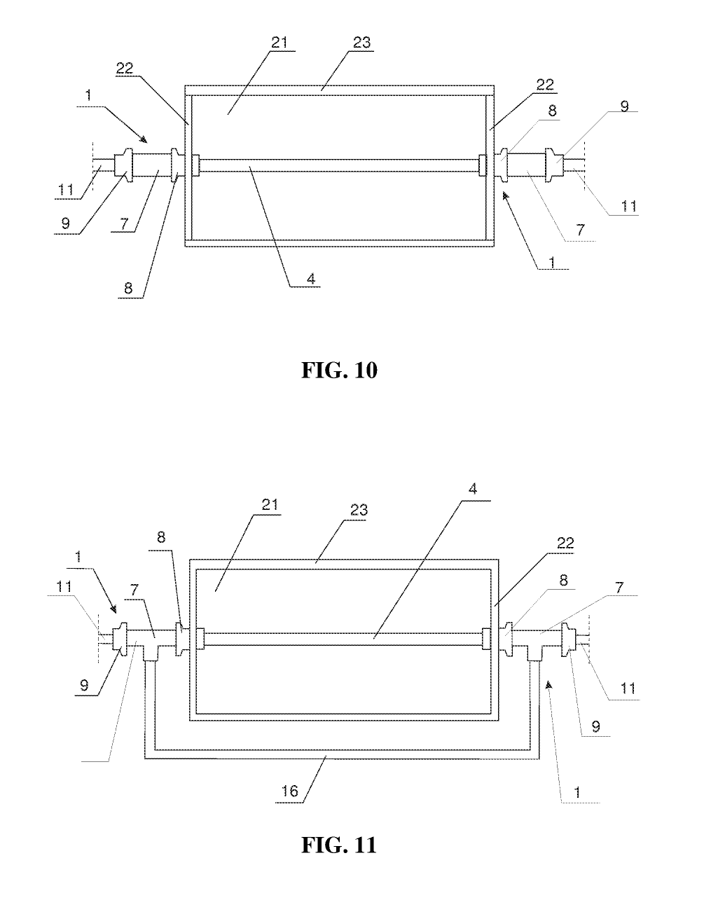

With reference to FIG. 10, the tubular radiation emitter 4 has the form of a filament emitting infrared radiation and is placed in the reflector 21. The radiation emitter 4 is disposed together with the protective cover 1 in fixing elements 22 connected with the housing 23 of the heating radiator. The fixing elements 22 encroach into grooves 10 of gaskets 8 made of high temperature-resistant silicone. Each of the gaskets 8 at the internal side of the fixing element 22 encloses the radiation emitter 4 whereas at the external side of fixing element 22 encloses tightly the profile of the passage 7. The passage 7 is made of a material having heat conducting properties, e.g., of copper. At the other side, the passage 7 and insulation 11 of the power cord 5 are enclosed by the gasket 9 made of high temperature-resistant silicone.

### EXAMPLE 6

With reference to FIGS. 8 and 11, the heating radiator with the infrared radiation emitter is as described in Example 5, except that the passage 7 has a T-shape and the radiator 16 is connected with the passage 7 and has the form of a curved profile extending out beyond the radiator housing 23.

### EXAMPLE 7

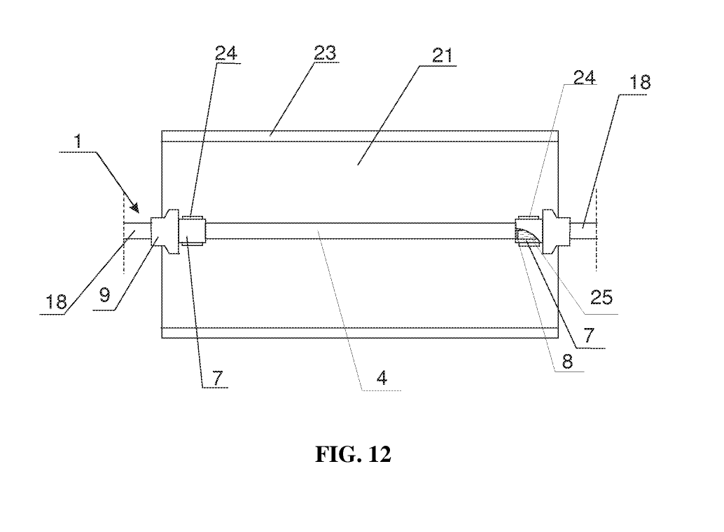

With reference to FIG. 12, the tubular radiation emitter 4, is disposed together with the protective cover 1 in the brackets 24 fixed to the reflector 21. The brackets 24 are made in the form of elastic elements into which the radiation emitter 4 together with the protective cover 1 are snapped-in. The space in the passage 7 is additionally filled with a cooling agent 25. The protective cover 1 at the side of the tubular radiation emitter 4 is provided with the gasket 8 that encroaches into the passage 7. In this example, at the side of the power cord 5, the protective cover 1 is used in the embodiment comprising the insulation 17 of the power cord 5.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. A waterproof and/or dustproof protection device for an electrical connector in a tubular radiation emitter disposed in a housing, comprising a protective cover, said protective cover comprising a passage and a plurality of gaskets, wherein
the protective cover forms an airtight space within which the electrical connector is placed;
the protective cover is a separate element, not related by shape to the housing of the tubular radiation emitter;
the passage, at one of its ends, adheres circumferentially with its inner or outer surface to a first gasket disposed at one end of the tubular radiation emitter, and, at its other end, adheres circumferentially with its inner or outer surface to a second gasket; and
said second gasket adheres to an insulation of a power cord.

2. The device of claim 1, wherein the insulation of a power cord comprises a flanged metal sleeve and an elastic insulation material, and the elastic insulation material is clamped to the flanged metal sleeve.

3. The device of claim 1, wherein the insulation of a power cord surrounds the power cord in its entire length up to an electrical plug.

4. The device of claim 1, wherein
the first gasket has a tubular shape with a first longitudinal through-hole;
the cross-section of the first longitudinal through-hole matches at one end to the outer surface of the passage and at another end to the outer surface of the tubular radiation emitter;
the second gasket has a tubular shape with a second longitudinal through-hole; and
the cross-section of the second longitudinal through-hole matches at one end to the outer surface of the passage and at another end to the insulation of a power cord.

5. The device of claim 1, wherein
the first gasket is made of at least two separate parts, said two separate parts being joined form a tubular structure, said tubular structure being tightly fit to the inside surface of the passage and being tightly fit to the outer surface of the tubular radiation emitter to which it is fixed; and
said separate gasket parts are joined with a bonding agent.

6. The device of claim 1, wherein the passage has a straight or curved axis of symmetry and comprises at least one tubular section having a through-hole and/or a T-shaped section.

7. The device of claim 1, wherein the passage further comprises at least one radiator or the passage is connected to at least one radiator.

8. A heating radiator comprising a tubular radiation emitter disposed in a housing, and at least one an electrical connector for connecting said tubular radiation emitter to a power cord, wherein said electrical connector is enclosed by the device of claim 1.

9. A heating radiator comprising a tubular radiation emitter disposed in a housing, and at least one an electrical connector for connecting said tubular radiation emitter to a power cord, wherein said electrical connector is enclosed by the device of claim 2.

10. A heating radiator comprising a tubular radiation emitter disposed in a housing, and at least one an electrical connector for connecting said tubular radiation emitter to a power cord, wherein said electrical connector is enclosed by the device of claim 3.

11. A heating radiator comprising a tubular radiation emitter disposed in a housing, and at least one an electrical connector for connecting said tubular radiation emitter to a power cord, wherein said electrical connector is enclosed by the device of claim 4.

12. A heating radiator comprising a tubular radiation emitter disposed in a housing, and at least one an electrical connector for connecting said tubular radiation emitter to a power cord, wherein said electrical connector is enclosed by the device of claim 5.

13. A heating radiator comprising a tubular radiation emitter disposed in a housing, and at least one an electrical connector for connecting said tubular radiation emitter to a power cord, wherein said electrical connector is enclosed by the device of claim 6.

14. A heating radiator comprising a tubular radiation emitter disposed in a housing, and at least one an electrical connector for connecting said tubular radiation emitter to a power cord, wherein said electrical connector is enclosed by the device of claim 7.

15. The radiator of claim 8, wherein the first gasket and the second gasket are made of high temperature-resistant elastic material.

16. The radiator of claim 8, wherein the protective cover is made of a heat conducting material.

17. The radiator of claim 16, wherein the protective cover is made of copper.

18. The radiator of claim 8, wherein the passage is filled with a cooling agent.
